(19) United States
(12) Patent Application Publication
(10) Pub. No.: US 2007/0272541 A1
(43) Pub. Date: Nov. 29, 2007

(54) Method for generating hydrogen gas and generator for the same

(75) Inventor: Masayoshi Kitada, Saitama (JP)

Correspondence Address: KRATZ, QUINTOS & HANSON, LLP, 1420 K Street, N.W., Suite 400, WASHINGTON, DC, 20005, US

(73) Assignee: HONDA MOTOR CO., LTD., Tokyo (JP)

(21) Appl. No.: 11/798,088

(22) Filed: May 10, 2007

(30) Foreign Application Priority Data
May 26, 2006 (JP) 2006-147092

(51) Int. Cl. A62D 3/00; B01J 19/08

(52) U.S. Cl. 204/157.43; 422/186

(57) ABSTRACT

There is provided a method for generating hydrogen gas, which is a clean fuel, including irradiating infrared rays with exclusive wavelengths in a range of from 2.8 to 3.2 μm to water.

### CROSS-REFERENCE TO RELATED APPLICATIONS

This application claims the foreign priority benefit under Title 35, United States Code, section 119 (a)-(d), of Japanese Patent Application No. 2006-147092, filed on May 26, 2006 in the Japan Patent Office, the disclosure of which is herein incorporated by reference in its entirety.

### BACKGROUND OF THE INVENTION

1. Field of the Invention

The present invention relates to a method for generating hydrogen gas in which far-infrared rays with a specific wavelength that causes resonance vibration of water molecules are irradiated to water molecules. The present invention also relates to a hydrogen gas generator.

2. Description of the Related Art

Hydrogen gas has drawn attention as a clean fuel that will substitute for existing fuels, such as petroleum, since hydrogen does not generate carbon dioxide when burnt. As a method for generating hydrogen gas, there can be mentioned a method in which a hydrogen-containing compound, such as water and methanol, is decomposed. However, in such a method for generating hydrogen gas, thermal or electric energy is required for decomposition. Electric energy or the like is obtained generally by burning petroleum or natural gas, which is accompanied by emission of carbon dioxide. Therefore, hydrogen gas obtained from de-composition of a hydrogen-containing compound, such as water and methanol, is not necessarily a clean fuel from a viewpoint of a generation process thereof.

On the other hand, there can be mentioned a method for generating hydrogen gas in which solar rays are utilized to decompose water or the like. In this case, merely a preparation of a device is required for generating hydrogen gas, without supplying external energy, such as electricity. Since harmful substance is not emitted, hydrogen gas thus obtained is considered as a clean fuel. As for a conventional method for generating hydrogen gas utilizing solar rays, there is a method in which hydrogen is generated by irradiating solar rays to titanium oxide as a photocatalyst in water or methanol, for example.

However, in the conventional method for generating hydrogen gas utilizing solar rays, only ultraviolet rays having relatively high energy are utilized from among rays included in solar rays, and no proposal has been made with respect to a method utilizing visible light or infrared rays included in solar rays, for hydrogen gas generation. Ultraviolet rays are merely a small part of rays included in solar rays, and therefore, if visible light or infrared rays are utilized, hydrogen gas can be efficiently generated utilizing solar rays.

Therefore, it would be desirable to provide a method for generating hydrogen gas in which infrared rays are utilized that had not been utilized in the conventional method for generating hydrogen gas.

### SUMMARY OF THE INVENTION

In one aspect of the present invention, there is provided a method for producing hydrogen gas comprising irradiating infrared rays with exclusive wavelengths in a range of from 2.8 to 3.2 μm to water.

In another aspect of the present invention, there is provided a hydrogen gas generator including a means for irradiating infrared rays with exclusive wavelengths in a range of from 2.8 to 3.2 μm to water; and a means for collecting gas including hydrogen gas generated by the irradiation.

### BRIEF DESCRIPTION OF THE DRAWINGS

The various aspects, other advantages and further features of the present invention will become more apparent by describing in detail illustrative, non-limiting embodiments thereof with reference to the accompanying drawings.

FIG. 1 shows a schematic diagram of a principle of the method for generating hydrogen gas according to one embodiment of the present invention; FIG. 1A is a diagram showing a state in which water molecules are absorbing infrared rays and excited; FIG. 1B is a diagram showing a state in which water molecules that have absorbed infrared rays are excited and resonated, and collide with one another; and FIG. 1C is a diagram showing a state in which water molecules is decomposed by the collisions and hydrogen gas is generated.

FIG. 2 is a graph showing absorption spectrum of light by water molecules.

FIG. 3 is a diagram showing a generator of hydrogen gas utilizing a method for generating hydrogen gas according to one embodiment of the present invention.

### DETAILED DESCRIPTION OF THE EXEMPLARY EMBODIMENTS

Embodiments of the present invention will be described in detail below with reference to the drawings.

First, an embodiment of the method for generating hydrogen gas of the present invention will be described. In the method of the present invention, water molecules are decomposed and hydrogen gas is generated, by irradiating infrared rays with exclusive wavelengths in a range of from 2.8 to 3.2 μm (wavelength of 2.8 μm or more and 3.2 μm or less) to water.

In the method for generating hydrogen gas of the present embodiment, water molecules are in a state of liquid or gas and mobile. The infrared rays with wavelengths in a range of from 2.8 to 3.2 μm may be, for example, infrared light obtained by collecting solar rays with a Fresnel lens or the like; the solar rays having been modified to have a wavelength in a range of from 2.8 to 3.2 μm by passing through a filter or the like; a solid-state laser beam (oscillation wavelength: 2.94 μm) obtained using a YAG (yttrium-aluminum-gadolinium) crystal with Er (erbium) ions emitting fluorescence added thereto. In the case of the infrared light obtained from solar rays also, it is preferred that the light be converted into a laser beam, since higher output intensity generates more hydrogen gas.

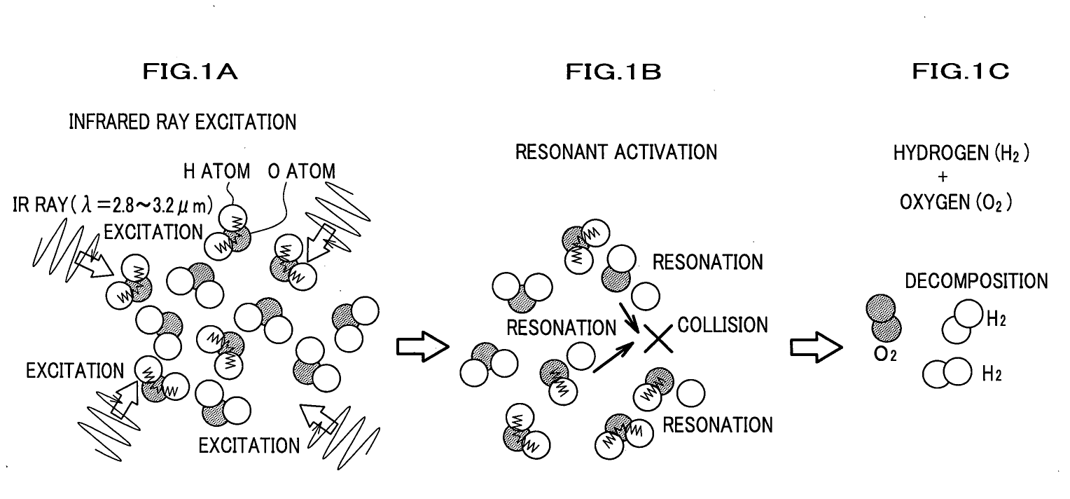

In the method for generating hydrogen gas of the present embodiment, as shown in FIG. 1A, there is utilized the fact that water molecules vibrate when they have absorbed infrared rays with wavelengths in a range of from 2.8 to 3.2 μm.

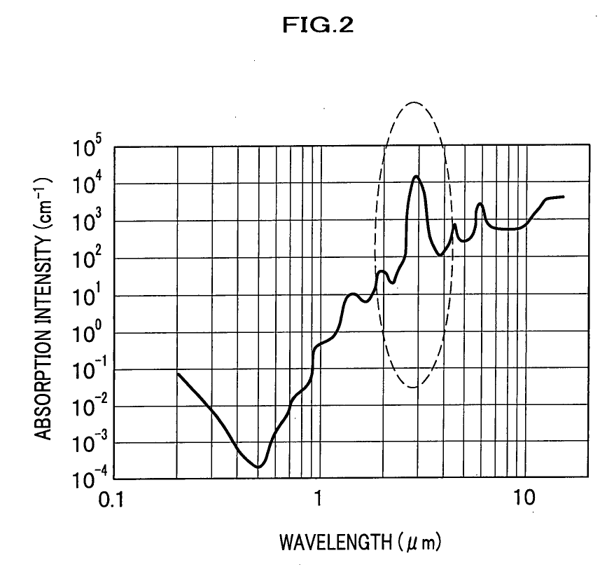

As shown in FIG. 2, water molecules well absorb light having wavelengths in a vicinity of 3 μm, which is in the range of what is called far-infrared rays. The reason for this absorption is that a frequency of light with wavelength of approximately 3 μm agrees with a natural resonance frequency of a pair of OH bondings in a water molecule in a stretching direction. Therefore, when water vapor gas is irradiated with infrared rays with wavelengths in a range of from 2.8. to 3.2 μm, the water molecule absorbs infrared rays, and thus is excited and resonated.

Accordingly, in the method for generating hydrogen gas of the present embodiment, infrared rays with exclusive wavelengths in a range of from 2.8 to 3.2 μm is irradiated to water molecules in vapor, to cause excitation and resonation of water molecules as described above (see FIG. 1A). When irradiation of infrared light with the specific wavelength as described above is continued, the excited and resonated water molecules in vapor collide with one another (see FIG. 1B). Due to these collisions of excited and resonated water molecules, OH bondings of a water molecule are broken, to thereby generate hydrogen gas (H₂) and oxygen gas (O₂) (see FIG. 1C). It should be noted that, in the method for generating hydrogen gas of the present embodiment, excited and resonated water molecules collided are in a state of gas.

On the other hand, when infrared rays with the above-mentioned specific wavelength is irradiated to water in a state of liquid, hydrogen can also be generated. When infrared rays having the predetermined exclusive wavelength as described above are irradiated to water in a state of liquid, and a water temperature is sufficiently high, water to which infrared rays are irradiated is easily evaporated and forms bubbles. Further irradiation of the above-mentioned infrared rays to the bubbles excites and resonates water molecules, and in the same manner as in the case of water vapor described above, water molecules collide with one another to thereby generate hydrogen gas (H₂) and oxygen gas (O₂). Therefore, according to the method for generating hydrogen gas of the present embodiment, by irradiating infrared rays with exclusive wavelengths in a range of from 2.8 to 3.2 μm to water in a state of either gas or liquid, hydrogen gas can be generated.

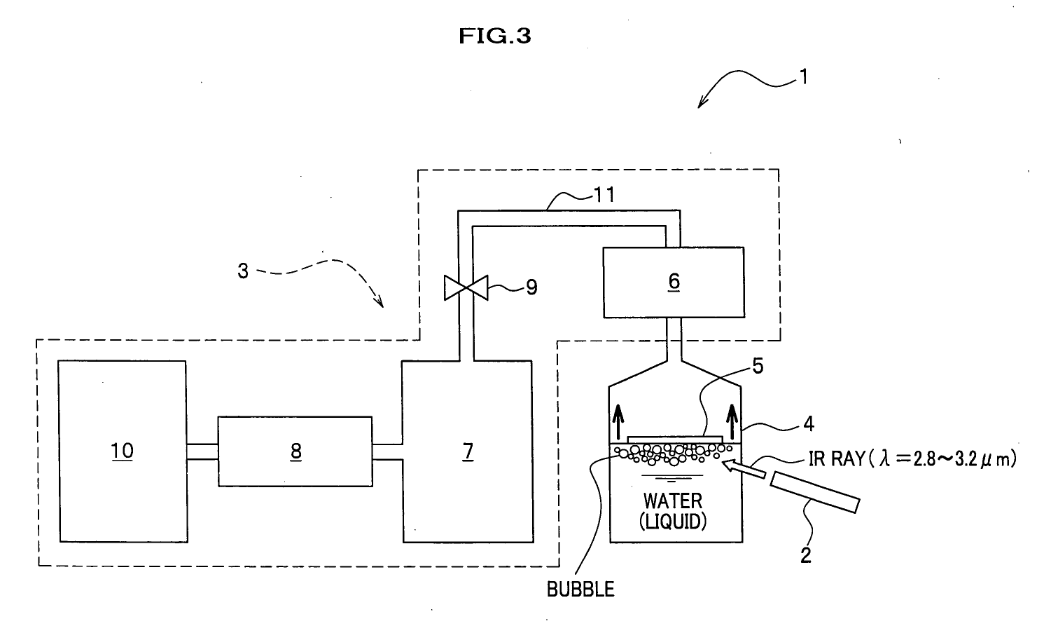

Next, a configuration of the hydrogen gas generator according to one embodiment of the present invention will be described with reference to FIG. 3. A hydrogen gas generator 1 in the present embodiment includes an infrared ray irradiator 2, a hydrogen gas collector 3 and a reaction vessel 4.

In the infrared ray irradiator 2, there are used infrared rays obtained by collecting solar rays with a Fresnel lens and the like, the solar rays having been modified to have a wavelength in a range of from 2.8 to 3.2 μm by passing through a filter or the like; or Er-YAG laser beam. The reaction vessel 4 preferably has an excellent transmittance, for example, of 90% or more, to infrared rays with wavelengths of 2.8 μm-3.2 μm.

A side wall of the reaction vessel 4 may be perforated and the infrared ray irradiator 2 may be inserted therein, to close the hole and fix the infrared ray irradiator 2. The reaction vessel 4 contains water to be irradiated with infrared rays. It is preferred that the water contained in the reaction vessel 4 be heated, since bubbles are efficiently formed when infrared light is irradiated on water at a higher temperature. On a surface of the water in the reaction vessel 4, a bubble reservoir 5 is provided. The bubble reservoir 5 is configured for accumulating bubbles formed from water that has absorbed infrared rays. The shape of the bubble reservoir 5 is not specifically limited, as long as it floats on water surface or is fixed in the water in such a manner that the bubble reservoir 5 covers a part of water where bubbles are formed.

When water molecules are irradiated with infrared rays with wavelengths in a range of from 2.8 to 3.2 μm by the infrared ray irradiator 2, the water molecules absorb nearly 100% of the infrared rays, evaporate and form bubbles. These bubbles are accumulated under the bubble reservoir 5, and infrared rays with wavelengths in a range of from 2.8 to 3.2 μm is further irradiated to the bubbles, which excites and resonates water molecules in the bubbles as shown in FIGS. 1A and 1B. Collisions of these excited and resonated water molecules to one another generate hydrogen gas.

The hydrogen gas collector 3 is mainly formed of a dehumidifier 6, a generated-gas tank 7, a hydrogen gas separator 8 and a hydrogen gas tank 10. The dehumidifier 6 is provided with a molecular sieve and the like. Therefore, when the gas generated in the reaction vessel 4 passes through the dehumidifier 6, water vapor contained in the generated gas is removed. The generated gas that has passed through the dehumidifier 6 further passes through a piping 11 and reaches the generated-gas tank 7. The hydrogen gas separator 8 is provided with a selective permeable membrane for hydrogen gas, and pressurizes the generated gas in the generated gas tank 7 to thereby selectively separate the hydrogen gas. Upon the operation of the hydrogen gas separator 8, a valve 9 is closed.

The present inventor demonstrated that the above-mentioned method for generating hydrogen gas of the present embodiment can generate hydrogen gas, by conducting the following test.

### <Test Method>

Water was stored at 79° C. in the reaction vessel 4 shown in FIG. 3, and the bubble reservoir 5 was placed above the surface of the water. Infrared rays were irradiated to an upper part of the water in the reaction vessel 4. The reaction vessel 4 has 90% transmittance for infrared rays with wavelengths of 2.8 μm-3.2 μm. Infrared rays were irradiated with a laser irradiator A-CURE (manufactured by Cyber Laser Inc.). The irradiated infrared rays were pulsed laser beam.

The pulsed laser beam has a wavelength of 2.95 μm, a pulse width of 500 μsec, a pulse frequency of 40 Hz, a irradiation spot diameter of approximately 1.5 mm and an output per pulse of 39 mJ. The infrared rays were irradiated for 90 minutes.

### <Result>

The gas generated in the above-mentioned test was collected using a gas collection bag made of aluminum that contained 25 ml of air. An amount of the collected gas was 0.13 ml. Approximately 25 ml of gas in the collection bag containing 0.13 ml of the generated gas was allowed to pass a molecular sieve, and then quantitative assay was performed with gas chromatography. A gas chromatography device GC323 TDC (manufactured by GL Sciences Inc.) was used for the assay. The quantitative assay with gas chromatography revealed that the assayed gas contained 0.003% hydrogen gas. From this result, it was confirmed that 0.00075 ml of hydrogen gas was generated in this test. The result also shows that, since a photon number of the irradiated infrared rays was 1.1×10²³, one hydrogen gas molecule was generated relative to 5.6×10⁶ of photon of the irradiated infrared rays.

According to the method of the present invention as described above, by simply irradiating infrared rays (having a specific wavelength), that has been utilized only as heat ray, to water in a state of vapor or liquid, hydrogen gas can be generated. In addition, by utilizing the hydrogen gas generator 1 of the present invention, hydrogen gas can be generated and collected. Therefore, not by using thermal energy or electrical energy, but by simply irradiating far-infrared rays contained in solar rays to water, it becomes possible to generate hydrogen gas and to efficiently utilize solar rays. This will meet the future requirement in, for example, a field of fuel cell that uses a large amount of hydrogen gas.

What is claimed is:

1. A method for generating hydrogen gas comprising irradiating infrared rays with exclusive wavelengths in a range of from 2.8 to 3.2 μm to water.

2. A hydrogen gas generator comprising:
a means for irradiating infrared rays with exclusive wavelengths in a range of from 2.8 to 3.2 μm to water; and
a means for collecting gas including hydrogen gas generated by the irradiation.
